(19) United States
(12) Patent Application Publication
(10) Pub. No.: US 2011/0065312 A1
(43) Pub. Date: Mar. 17, 2011

(54) METHOD FOR CODING FLEXIBLE CO-AXIAL CABLE CONNECTORS

(76) Inventor: John Bies, Huntsville, AL (US)

(21) Appl. No.: 12/719,713

(22) Filed: Mar. 8, 2010

Related U.S. Application Data
(60) Provisional application No. 61/158,209, filed on Mar. 6, 2009.

(51) Int. Cl. H01R 3/00

(52) U.S. Cl. 439/491

(57) ABSTRACT

A method for identifying flexible co-axial cable connectors by connection type has been developed. The method includes marking the co-axial connector with a colored indicator and marking the proper receptor with a matching colored indicator.

### CROSS-REFERENCE TO RELATED APPLICATIONS

This application claims priority from U.S. Provisional Patent Application No. 61/158,209 titled “METHOD FOR CODING FLEXIBLE CO-AXIAL CABLE CONNECTORS” that was filed on Mar. 6, 2009.

### BACKGROUND ART

1. Field of the Invention

The invention relates generally to electrical cable connectors. More specifically, the present invention relates to a method for coding flexible co-axial cable connectors.

2. Background Art

Coaxial cables are often used as a transmission line for radio frequency signals. It is a cable that includes an inner conductor, surrounded by a tubular insulating layer typically made from a flexible material with a high dielectric constant, all of which is then surrounded by another conductive layer (typically of fine woven wire for flexibility, or of a thin metallic foil), and then finally covered again with a thin insulating layer on the outside. The term coaxial comes from the inner conductor and the outer shield sharing the same geometric axis. A coaxial cable provides protection of signals from external electromagnetic interference, and effectively guides signals with low emission along the length of the cable. FIG. 1 shows a cut away view of a coaxial cable.

A connector between coaxial cables usually has the same impedance as the related cable and probably has a similar cutoff frequency although its dielectric may be different. Some connectors are gold or rhodium plated, while some connectors use nickel or tin plating. Silver is also used due to its excellent conductivity. FIG. 2 shows various examples of connectors for coaxial cables.

As can be seen in FIG. 2, the types of connector may vary widely. However, different types of connectors may be mechanically capable of mating together but in fact may be completely incompatible. This is especially true in connectors for high frequency cables. For example, FIG. 3 shows a comparison view of slotted and slotless connectors for coaxial cables. In this case, mating a slotless connector with a corresponding slotted component would result in damage to that component.

In summary, the difficulty in distinguishing between different coaxial connector types could result in serious risk of damaged equipment, degraded reliability and performance, reduced readiness, and lost efficiency. Consequently, a method of rapidly identifying compatible connectors for coaxial cables is needed.

### SUMMARY OF THE INVENTION

In some aspects, the invention relates to a method for identifying coaxial connectors, comprising: step for identifying a type of flexible co-axial cable connector with a colored indicator; and step for identifying a matching receptor for the connector with a matching colored indicator.

In other aspects, the invention relates to a method for identifying coaxial connectors, comprising: providing a connector for a flexible co-axial cable with a colored indicator; and providing a receptor matched to the connector with a matching colored indicator.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a cut away view of a coaxial cable.

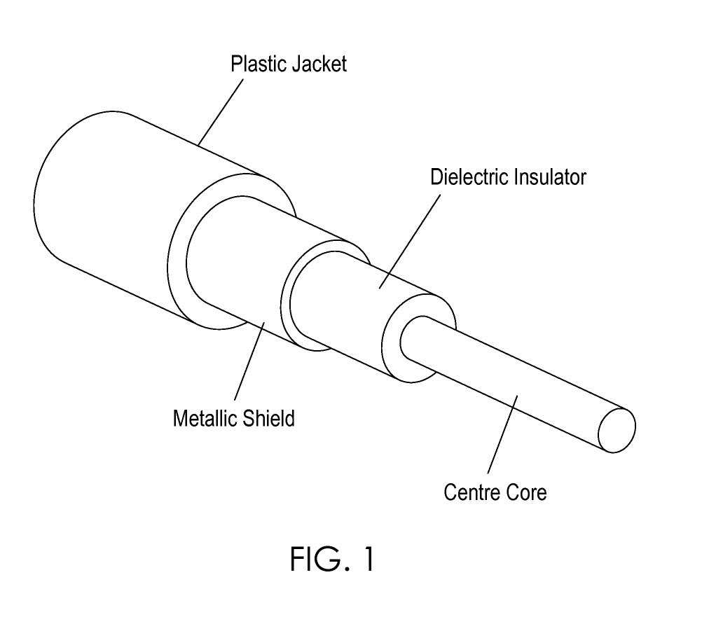

FIG. 2 shows various examples of connectors for coaxial cables.

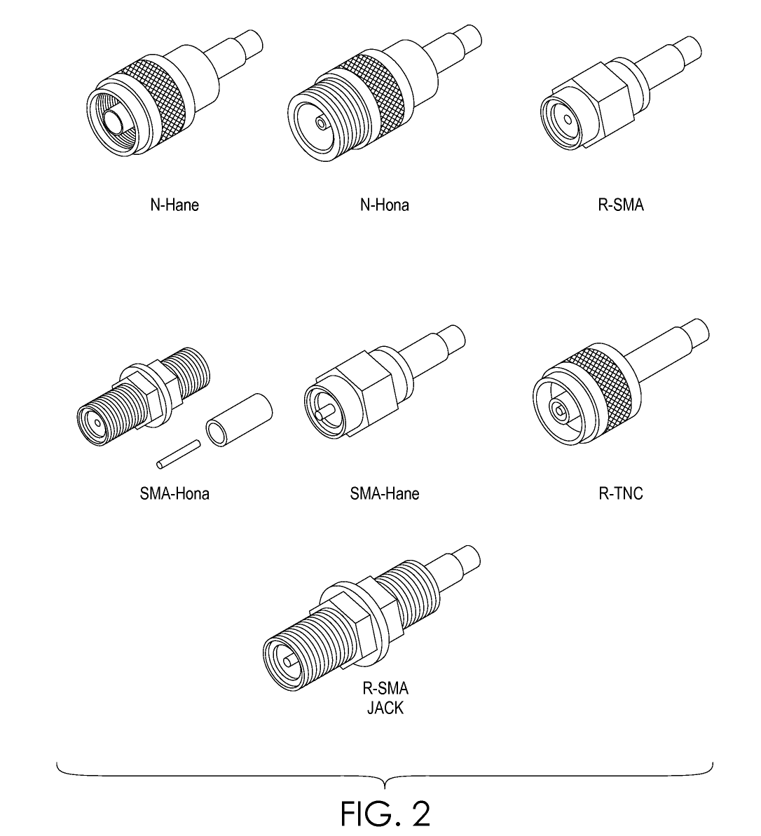

FIG. 3 shows a comparison view of slotted and slotless connectors for coaxial cables.

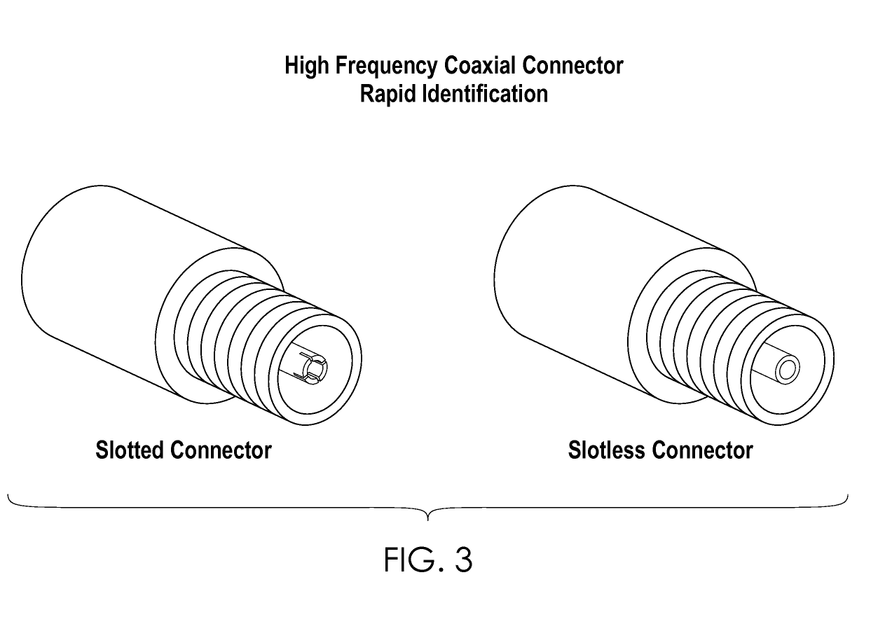

FIG. 4 shows an example of two attached connectors with a colored band in place.

FIG. 5 shows one embodiment of a color scheme for connectors in accordance with the present invention.

### DETAILED DESCRIPTION

A method for coding and identifying flexible coaxial connectors has been developed. The method involves using color coded bands that are installed on each connector and its appropriate mate. This has the advantage of quickly and easily allowing a user to identify and appropriate connectors especially for high frequency coaxial cables.

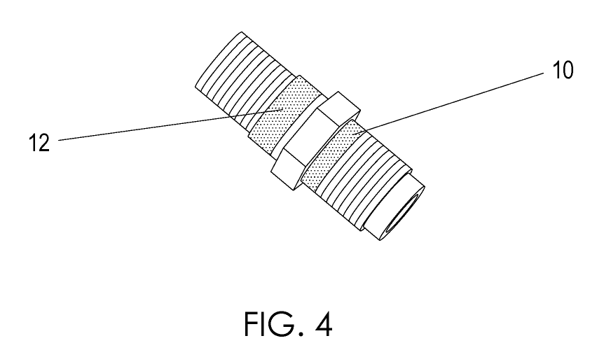

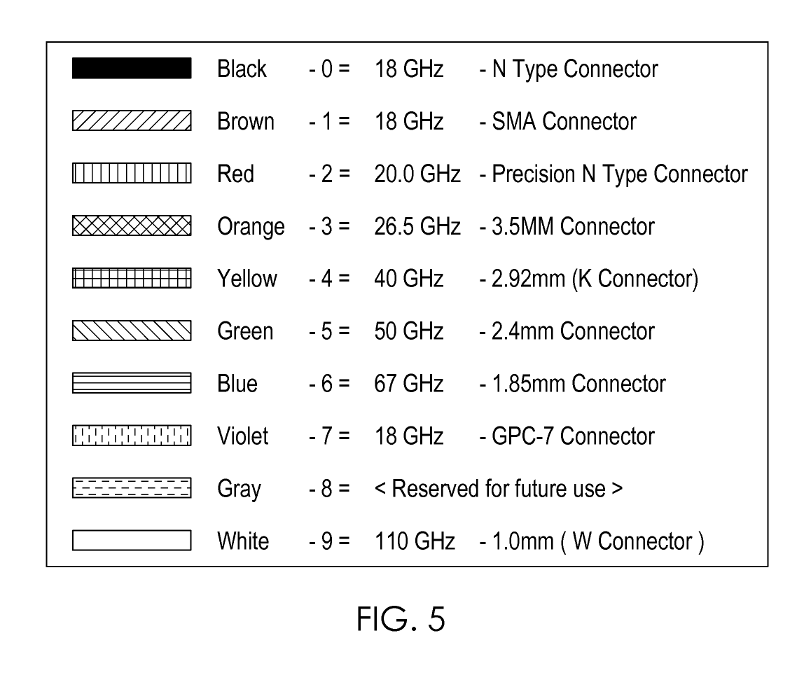

FIG. 4 shows an example of two attached connectors 10 with a colored band 12 in place. The band would have a unique color to identify the type of cable. Ideally, the band would mate with another connector of the same color if a cable to cable connection was being made. A non-cable connection to equipment, etc. could also use a color coding system. In this case, the connector on the equipment could use a band or have the color displayed in another manner at or near the connector on the equipment. FIG. 5 shows one embodiment of a color scheme for connectors. The chart shows ten separate color schemes to identify different types of high frequency coaxial cables. However, it should be clear that other color schemes could be used to identify these or other types of connectors.

In the embodiment of the present invention shown in FIG. 5, the following color scheme for connectors is used:
Black=18 GHz—N Type connector (75 Ohm only)
Brown=18 GHz—SMA connector
Red=20.0 GHz—Precision N Type connector
Orange=26.5 GHz—3.5 mm connector
Yellow=40 GHz—2.92 mm (K connector)
Green=50 GHz—2.4 mm connector
Blue=67 GHz—1.85 mm (V connector)
Violet=18 GHz GPC—7 connector
Gray=<Reserved for future use>
White=110 GHz—1.0 mm (W connector)

For example in this embodiment: an 18 GHz SMA connector would have a Brown stripe 360 degrees all the way around the connector; a 20 GHz Precision N connector would have a Red stripe 360 degrees all the way around; a 26.5 GHz (26.5 rounded up) 3.5 mm connector would have an Orange stripe 360 degrees all the way around the connector; a 50 GHz 2.4 mm connector would have a Green stripe 360 degrees all the way around the connector; etc.

This method of installation would be very clear to the technicians who work with these connectors since near instantaneous connector identification possible without the need for handling the connector. Connector identification possible at a distance of greater than four feet from the average persons eye without the need for handling the connector. Additionally, connector mismatch identification is possible at a distance of greater than four feet from the average person's eye. For example, a 18 GHz SMA and a 40 GHz 2.92 mm(K) will mate non-destructively. However, the maximum frequency for this mismatched type of connection can handle only 18 GHz, not 40 GHz. This type of identification can be obtained by marking a colored band all way around the connectors in areas where the color marking is still easily visible after mating.

The present invention has the clear benefit of offsetting cost due to greater equipment reliability and results in less damage to connectors and equipment. It should be clear, in view of the preceding text that the present invention includes a method for coding and identifying flexible coaxial connectors. This invention has the advantage of easily and quickly identifying compatible connectors for coaxial cables. While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A method for identifying coaxial connectors, comprising:
step for identifying a type of flexible co-axial cable connector with a colored indicator; and
step for identifying a matching receptor for the connector with a matching colored indicator.

2. A method for identifying coaxial connectors, comprising:
providing a connector for a flexible co-axial cable with a colored indicator; and
providing a receptor matched to the connector with a matching colored indicator.

3. The method of claim 2, where the colored indicator is a stripe around the circumference of the connector.

4. The method of claim 2, where the colored indicator of the connector and the matching colored indicator of the receptor are black to indicate a 18 GHz N-Type connector.

5. The method of claim 2, where the colored indicator of the connector and the matching colored indicator of the receptor are brown to indicate a 18 GHz SMA connector.

6. The method of claim 2, where the colored indicator of the connector and the matching colored indicator of the receptor are red to indicate a 20.0 GHz Precision N-Type connector.

7. The method of claim 2, where the colored indicator of the connector and the matching colored indicator of the receptor are orange to indicate a 26.5 GHz 3.5 mm connector.

8. The method of claim 2, where the colored indicator of the connector and the matching colored indicator of the receptor are yellow to indicate a 40 GHz 2.92 mm (K) connector.

9. The method of claim 2, where the colored indicator of the connector and the matching colored indicator of the receptor are green to indicate a 50 GHz 2.4 mm connector.

10. The method of claim 2, where the colored indicator of the connector and the matching colored indicator of the receptor are blue to indicate a 67 GHz 1.85 mm (V) connector.

11. The method of claim 2, where the colored indicator of the connector and the matching colored indicator of the receptor are violet to indicate a 18 GHz GPC-7 connector.

12. The method of claim 2, where the colored indicator of the connector and the matching colored indicator of the receptor are white to indicate a 110 GHz 1.0 mm (W) connector.
